(19) United States
(12) Patent Application Publication
(10) Pub. No.: US 2016/0318464 A1
(43) Pub. Date: Nov. 3, 2016

(54) GROMMET BRACKET

(71) Applicant: Sumitomo Wiring Systems, Ltd., Yokkaichi (JP)

(72) Inventor: Yuki OOHIRA, Yokkaichi (JP)

(21) Appl. No.: 15/138,487

(22) Filed: Apr. 26, 2016

(30) Foreign Application Priority Data
Apr. 30, 2015 (JP) 2015092662

(51) Int. Cl. B60R 16/02; H01B 17/58; H02G 3/22

(52) U.S. Cl. CPC B60R 16/0222; H02G 3/22; H01B 17/583

(57) ABSTRACT

A grommet bracket for attaching a grommet to a panel of a vehicle. The grommet bracket includes: an attachment portion that is arranged so as to extend along the surface of the panel, and is bolted to the panel; a pressing portion for pressing the grommet against the surface of the panel; and a coupling portion that is arranged so as to surround the grommet, and couples the attachment portion and the pressing portion. A draining hole, by which a gap formed between the coupling portion and the grommet is put into communication with the outside of the vehicle, is provided as an opening in the coupling portion.

This Application claims the benefit of Japanese Application No. JP2015-092662, filed on Apr. 30, 2015, the contents of which are hereby incorporated by reference in their entirety.

### FIELD

The technology disclosed by the present specification relates to a grommet bracket.

### BACKGROUND

Conventionally, the bracket disclosed in JP H7-29442A (hereinafter, referred to as Patent Document 1) is known as an example of a bracket used when a wiring harness arranged under the floor of a vehicle is pulled into the interior of the vehicle. This bracket is constituted by assembling a pair of bracket main bodies. Also, an elastic grommet that is to be fixed to a panel by the bracket has a bellows-shaped tube portion into which the wiring harness is inserted, and a flange portion for joining to the panel. Each of the bracket main bodies is provided with a pressing portion for pressing the flange portion toward the panel, and when the bracket main bodies are assembled and bolted to the panel, the flange portion is pressed against the panel, thus making it possible to reliably waterproof the junction between the panel and the elastic grommet.

However, in the above configuration, a continuous peripheral wall is formed when the pair of bracket main bodies are assembled, and since the flange portion is arranged inward of the peripheral wall, a gap is formed between the peripheral wall and the flange portion. Accordingly, if water is retained in this gap, it is possible that the bracket will become rusted, and there is a risk of the bracket becoming damaged when subjected to stress from the bolt fastening portion that fixes the bracket to the panel.

### SUMMARY

A grommet bracket disclosed by the present specification is a grommet bracket for attaching a grommet to a panel of a vehicle, the grommet bracket including: an attachment portion that can be arranged so as to extend along a surface of the panel, and can be bolted to the panel; a pressing portion for pressing the grommet against the surface of the panel; and a coupling portion that is arranged so as to surround the grommet, and couples the attachment portion and the pressing portion, wherein a draining hole, by which a gap formed between the coupling portion and the grommet is put into communication with the outside of the vehicle, is provided as an opening in the coupling portion.

According to this configuration, even if water intrudes into the gap formed between the coupling portion of the grommet bracket and the grommet, the water can be drained to the outside of the vehicle through the draining hole, thus making it possible to avoid rusting of the grommet bracket.

The grommet bracket disclosed by the present specification may have a configuration such as the following.

The coupling portion may be overall shaped as a crank, and may be configured to include a bottom wall that is continuous with an outer circumferential edge of the pressing portion, a peripheral wall that projects from an outer circumferential edge of the bottom wall in a direction of pressing the grommet, and a ceiling wall that protrudes from a projecting end edge of the peripheral wall toward a side opposite to the pressing portion, and the draining hole may be provided at a position in the bottom wall.

According to this configuration, if the grommet bracket is attached to the vehicle panel from below, water that intrudes into the gap moves toward the bottom wall due to gravity, and therefore due to providing the draining hole at a position in the bottom wall, water can be efficiently drained to the outside of the vehicle.

The grommet bracket may further include a protruding portion obtained by causing a portion of the peripheral wall to protrude to a side opposite to the pressing portion, and the draining hole may be provided at a position in the protruding portion.

According to this configuration, even in the case where, for example, the grommet is formed with a relatively large size, it is possible to avoid blockage of the draining hole by the grommet.

According to the grommet bracket disclosed by the present specification, water can be discharged to the outside of the vehicle through a draining hole, thus making it possible to avoid rusting of the grommet bracket.

### DRAWINGS

FIG. 1 is a cross-sectional view of a state in which a grommet bracket according to a first embodiment has been attached to a vehicle panel;

FIG. 2 is a front view of the grommet bracket according to the first embodiment; and

FIG. 3 is a front view of a grommet bracket according to a second embodiment.

### DESCRIPTION

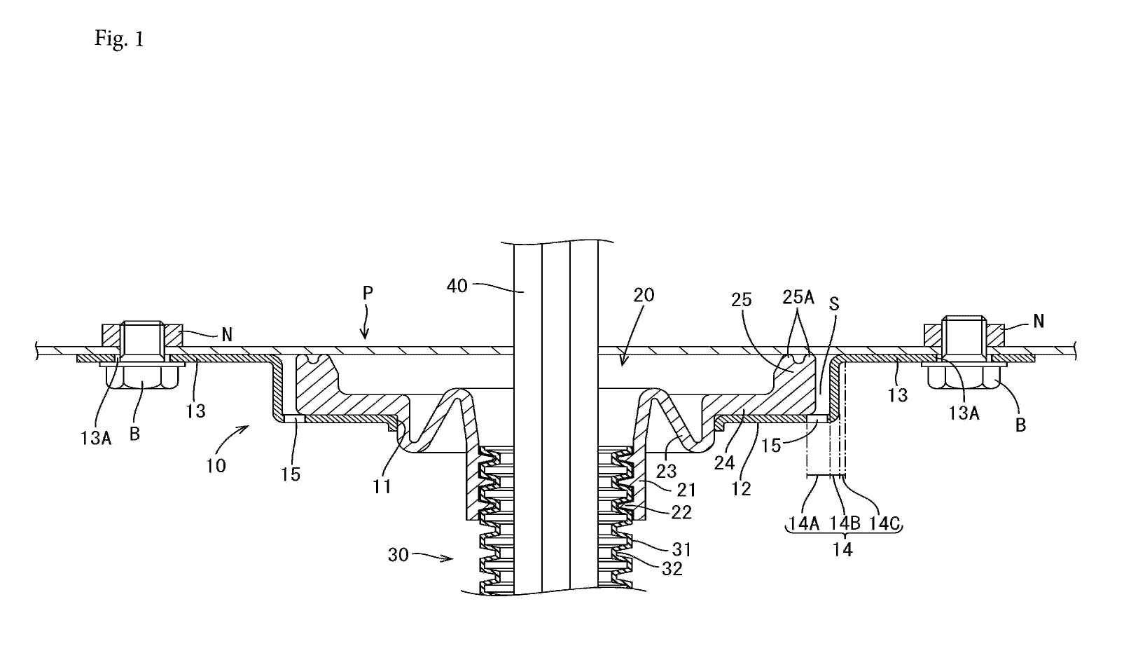

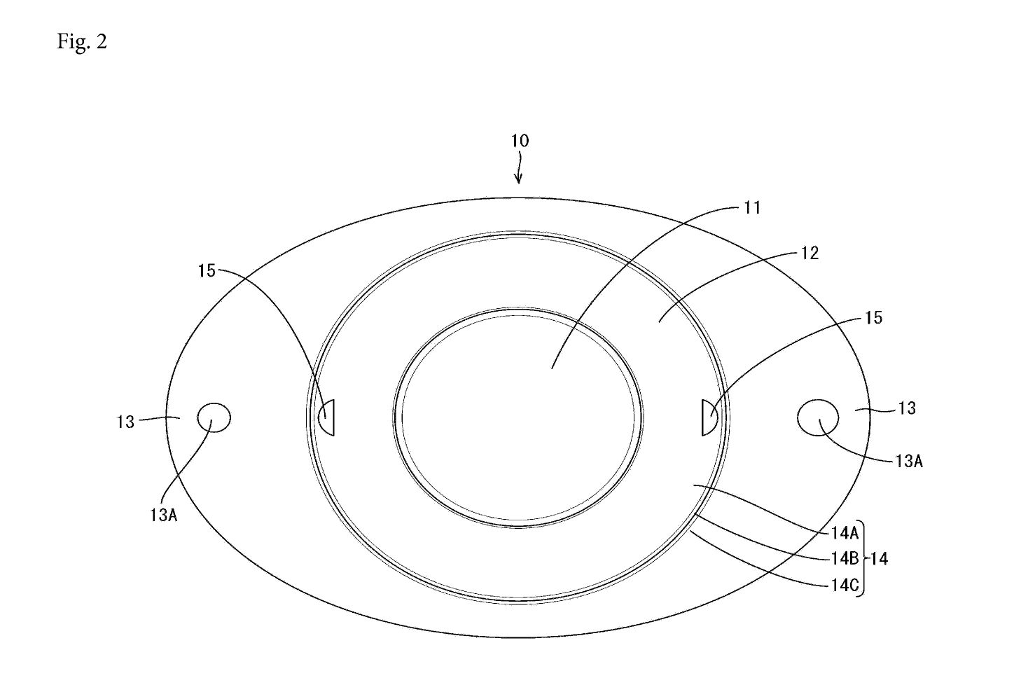

A first embodiment will be described below with reference to FIGS. 1 and 2. As shown in FIG. 1, a grommet bracket (hereinafter, referred to as a “bracket”) 10 of the present embodiment is an attachment member for attaching a grommet 20 to an underfloor panel P of a vehicle. The grommet 20 is made of rubber or an elastomer, functions as an exterior member that protects an electrical wire 40, and also functions as a sealing member that seals the junction between the underfloor panel P and the bracket 10.

A corrugated tube 30 is a known corrugated tube that is made of resin and is configured with a bellows shape in which mountain portions 31 and valley portions 32 are arranged side-by-side alternatingly. Also, the grommet 20 has a connection tube portion 21 provided such that an end portion of the corrugated tube 30 can be fitted therein, and multiple inner protrusion portions 22 are arranged side-by-side in the axial direction on the inner circumference of the connection tube portion 21. The pitch of the inner protrusion portions 22 matches the pitch of the valley portions 32. Accordingly, the corrugated tube 30 and the grommet 20 are connected to each other by fitting the end portion of the corrugated tube 30 into the connection tube portion 21 and then wrapping a tying band (not shown) around the connection tube portion 21.

The grommet 20 is configured to include a connection tube portion 21 into which the electrical wire 40 is inserted, a flexible portion 23 that extends continuously outward (away from the electrical wire 40) from the upper end portion of the connection tube portion 21 in a frilled manner, a lower sealing portion 24 that protrudes radially outward from the outer edge portion of the flexible portion 23, and an upper sealing portion 25 that projects upward from the outer edge portion of the upper surface of the lower sealing portion 24. The upper sealing portion 25 has two lips 25A arranged side-by-side in the radial direction.

The bracket 10 is obtained by pressing a metal plate, and is configured with an approximately uniform plate thickness. The bracket 10 is configured to include a ring-shaped pressing portion 12 at the center of which an insertion hole 11 for insertion of the flexible portion 23 of the grommet 20 is provided, an attachment portion 13 arranged to extend along the surface of the underfloor panel P, and a coupling portion 14 that couples the pressing portion 12 and the attachment portion 13. The attachment portion 13 is bolted to the underfloor panel P by a bolt B and a nut N. Accordingly, the lower sealing portion 24 is pressed upward by the upper surface of the pressing portion 12, and the upper sealing portion 25 is pressed against the surface of the underfloor panel P. The junction between the bracket 10 and the underfloor panel P is thus sealed by the lower sealing portion 24 and the upper sealing portion 25.

The pressing portion 12 and the attachment portion 13 are parallel to each other, and the attachment portion 13 is arranged upward relative to the pressing portion 12. For this reason, the coupling portion 14 is overall shaped as a crank, and is configured to include a bottom wall 14A that is continuous with the outer circumferential edge of the pressing portion 12, a peripheral wall 14B that projects from the outer circumferential edge of the bottom wall 14A in the direction of pressing the grommet 20 (upward), and a ceiling wall 14C that protrudes from the projecting end edge of the peripheral wall 14B toward the side opposite to the pressing portion 12. The bottom wall 14A is provided with draining holes 15 by which a gap S formed between the peripheral wall 14B and the grommet 20 is put into communication with the outside of the vehicle.

As shown in FIG. 2, the draining holes 15 have a semicircular shape and are provided at positions that are point symmetrical about the center of the insertion hole 11. The positions at which they are provided are also closest to attachment holes 13A in the attachment portion 13. Furthermore, the pair of draining holes 15 and the pair of attachment holes 13A are arranged to be aligned along a straight line. Accordingly, if water intrudes into the gap S through the attachment holes 13A, the water can be discharged to the outside of the vehicle through the draining holes 15, and it is possible to prevent the bracket 10 from becoming rusted and damaged.

As described above, according to the present embodiment, even in the case where water intrudes into the gap S formed between the coupling portion 14 of the grommet bracket 10 and the grommet 20, the water can be discharged to the outside of the vehicle through the draining holes 15, thus making it possible to avoid rusting of the grommet bracket 10.

Also, a configuration is possible in which the coupling portion 14 is overall shaped as a crank, and is configured to include the bottom wall 14A that is continuous with the outer circumferential edge of the pressing portion 12, the peripheral wall 14B that projects from the outer circumferential edge of the bottom wall 14A in the direction of pressing the grommet 20, and the ceiling wall 14C that protrudes from the projecting end edge of the peripheral wall 14B toward the side opposite to the pressing portion 12; and the draining holes 15 are provided at positions in the bottom wall 14A. According to this configuration, if the grommet bracket 10 is attached to the vehicle underfloor panel P from below, water that intrudes to the gap S moves toward the bottom wall 14A due to gravity, and therefore due to providing the draining holes 15 in the bottom wall 14A, water can be efficiently drained to the outside of the vehicle.

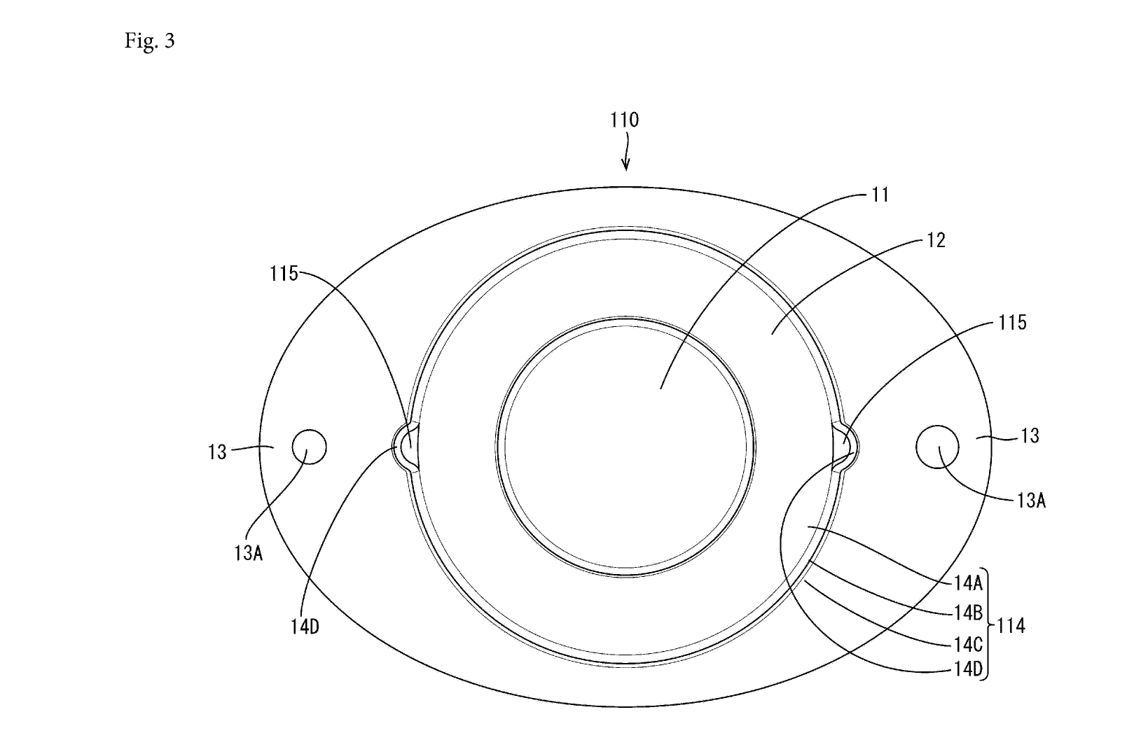

Next, a second embodiment will be described below with reference to FIG. 3. The present embodiment includes a modification to the positions of the draining holes 15 of the first embodiment, and configurations that are the same as in the first embodiment are denoted by the same reference signs. Specifically, a coupling portion 114 of a bracket 110 of the present embodiment includes protruding portions 14D obtained by causing portions of the peripheral wall 14B to protrude toward the side opposite to the pressing portion 12, and draining holes 115 of the present embodiment are provided at positions in the protruding portions 14D. In other words, although the draining holes 15 of the first embodiment and the draining holes 115 of the second embodiment are the same in that they are both provided at positions in the bottom wall 14A with respect to the up-down direction, they are different in that with respect to the diameter direction, the draining holes 115 of the second embodiment are located farther outward than the draining holes 15 of the first embodiment.

According to this configuration, even in the case where, for example, the grommet 20 is formed with a relatively large size, it is possible to avoid blockage of the draining holes 115 by the grommet 20.

The technology disclosed by the present specification is not limited to the embodiments described above using the foregoing description and drawings, and various configurations such as the following are also included in the present invention.

(1) Although the draining holes 15 and 115 are provided at positions in the bottom wall 14A of the coupling portion 14 in the above embodiments, the draining holes may be provided in the peripheral wall 14B or the ceiling wall 14C of the coupling portion 14 or 114.

(2) Although the bottom wall 14A of the coupling portion 14 is provided so as to be parallel with the attachment portion 13 in the above embodiments, the bottom wall may be formed with a tapered shape so as to extend downward as it approaches the peripheral wall 14B.

(3) Although the grommet 20 functions as an exterior member that protects the electrical wire 40 in the above embodiments, it may function as only a sealing member that blocks and seals a hole in the underfloor panel P, for example.

(4) Although the brackets 10 and 110 for attaching the grommet 20 to the underfloor panel P are shown as examples in the above embodiments, they may be a bracket for attaching the grommet 20 to a panel other than an underfloor panel.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A grommet bracket for attaching a grommet to a panel of a vehicle, the grommet bracket comprising:
an attachment portion that can be arranged so as to extend along a surface of the panel, and can be bolted to the panel;
a pressing portion for pressing the grommet against the surface of the panel; and
a coupling portion that is arranged so as to surround the grommet, and couples the attachment portion and the pressing portion;
wherein a draining hole, by which a gap formed between the coupling portion and the grommet is put into communication with the outside of the vehicle, is provided as an opening in the coupling portion.

2. The grommet bracket according to claim 1, wherein the coupling portion is overall shaped as a crank, and is configured to include a bottom wall that is continuous with an outer circumferential edge of the pressing portion, a peripheral wall that projects from an outer circumferential edge of the bottom wall in a direction of pressing the grommet, and a ceiling wall that protrudes from a projecting end edge of the peripheral wall toward a side opposite to the pressing portion, and the draining hole is provided at a position in the bottom wall.

3. The grommet bracket according to claim 2,
further comprising a protruding portion obtained by causing a portion of the peripheral wall to protrude to a side opposite to the pressing portion;
wherein the draining hole is provided at a position in the protruding portion.
